(19) United States
(12) Patent Application Publication
(10) Pub. No.: US 2026/0084899 A1
(43) Pub. Date: Mar. 26, 2026

(54) ATTACHMENT DEVICE FOR A CONVEYOR ROLLER

(71) Applicant: EXOTEC PRODUCT FRANCE, CROIX (FR)

(72) Inventors: Bastien CAGNAC, WASQUEHAL (FR); Damien VIVES, WASQUEHAL (FR)

(73) Assignee: EXOTEC PRODUCT FRANCE, CROIX (FR)

(21) Appl. No.: 19/339,966

(22) Filed: Sep. 25, 2025

(30) Foreign Application Priority Data
Sep. 25, 2024 (FR) FR2410261

(51) Int. Cl. B65G 39/12

(52) U.S. Cl. CPC B65G 39/12

(57) ABSTRACT

A device for attachment of an assembly shaft of a conveyor roller on a profile. The device includes a plate having an opening for the passage of the assembly shaft; a first clamping surface for engaging with the assembly shaft; and a first tightening hole. A tightening part includes a second clamping surface opposite the first clamping surface engaging with the assembly shaft; a second tightening hole; and a tightening member passing through the plate, the tightening part and the profile by their tightening holes. A ramp of the plate or the part causes the two clamping surfaces to approach together for clamping the assembly shaft.

### FIELD

The field of the present disclosure is that of conveyors, in particular conveyors present in order preparation warehouses.

### BACKGROUND

Using conveyors with rollers is known for transporting orders. Generally, conveyors comprise a structure comprising two lateral profiles on which cylindrical portions of rollers are assembled rotatably so as to cause the orders to advance. Typically the rollers are arranged parallel to each other, placed between the profiles, where each of the cylindrical portions pivots around an assembly shaft assembled fixed to the profiles. The distal ends of the assembly shaft therefore extend past the two longitudinal ends of each cylindrical portion and come to attach respectively on the two profiles, by respectively penetrating through receiving openings laid out in the profiles.

The receiving openings may be designed for having a shape complementary to that of the assembly shafts of the rollers, which may, for example, be hexagonal, so as to block the rotation of the assembly shafts on the profiles.

However, when the rollers are rotating, repeated friction of the assembly shafts of the rollers in the receiving openings leads to wear and deformation of said receiving openings. This may lead to a risk that the assembly shafts are not held fixed. There is also a need to more sustainably prevent the rotation of the assembly shafts through the receiving opening thereof in the profiles, so as to avoid parasitic movements and vibrations, or even a malfunction of the rollers.

In particular, a conveyor roller attachment device comprising three holding panels and an attaching means is known from the document U.S. Pat. No. 7,588,135. The holding panels all comprise one opening with a shape complementary to that of the assembly shaft of the roller and are placed one by one onto said shaft, against the profile of the conveyor. The panels each further comprise one through attachment hole which is needed for alignment, so as to pass the attachment means. For this purpose, the holding panels comprise at least one pair of male-female complementary shapes such that the adjacent panels engage with each other. For one pair of adjacent holding panels, the distance between the male-female complementary shape and the attachment hole of a holding panel of one of the pairs of adjacent holding panels is different from the distance between the male-female complementary shape and the attachment hole of the other holding panel of the pair of adjacent holding panels. In this way, the three holding panels align when they are assembled on each other coming to stop against different portions of the assembly shaft. The attachment means is assembled through three attachment holes and through one hole provided in the profile.

Further, a conveyor roller attachment device is known from patent JP 5,224,598 that essentially comprises an attachment means, a nut in two parts symmetric to each other and slightly frustoconically shaped, and two holding plates also symmetrical to each other and each comprising a frustoconical housing suited for each receiving a part of the nut. The nut and the holding plates are configured for receiving the assembly shaft of the conveyor roller. The attachment means is configured for attaching the attachment device to the profile of the conveyor and further serves to tighten or loosen the two holding plates between which the nut is arranged. Once assembled but not tightened, the two holding plates allow the nut some freedom of movement, in particular angular play in rotation around a vertical axis. Once tightened, the two holding plates fix the nut.

An attachment device for conveyor roller is also known from patent EP 4,015,418 A1 that essentially comprises an assembly plate provided with a first hole, a locking plate provided with a second hole offset relative to the first, and a ring inserted through the two holes. The insertion of the ring generates a lateral force that moves the plates in opposite directions, which tightens and locks the assembly shaft of the conveyor roller. This system improves the attachment of the assembly shaft of the roller and reduces vibrations.

Another attachment device also serving to reduce the vibrations is described in the patent DE 102005036756 B4. Typically it comprises a base body, securely attached to the chassis of a conveyor by means of a first screw, a support body that receives the end of the assembly shaft of the roller and an intermediate elastic layer between the base body and the support body, for reducing vibrations caused by the roller. The assembly shaft is tightened by a tightening wedge having a beveled surface and actuated by a second screw, screwed only in the support body. The first screw passes through the support body without touching it in order to prevent vibrations of the roller from reaching the chassis of the conveyor.

But these solutions have drawbacks. In particular, many parts need to be assembled with each other and installation of the parts is therefore complex. This complexity may have a direct impact on the assembly cost of the conveyor and on the reliability of holding the roller on the profile. In fact, the number of parts of the device proportionally increases the risk of forming play in the assembly due to the manufacturing deviation of each part, and it may result in harmful play that can be the origin of vibration in the conveyor.

The goal of the present disclosure is to remedy, at least in part, the disadvantages of the state-of-the-art cited above.

### SUMMARY

According to a first aspect, the objectives mentioned above are achieved in particular by a device for attachment of a conveyor roller on a profile, where the roller comprises a cylindrical portion and an assembly shaft extending projecting from a flank of the cylindrical portion, where the assembly shaft comprises a distal end passing through the profile by a receiving opening, and where the attachment device comprises:
a plate, comprising:
   a rear surface configured for resting against the profile;
   an opening configured for allowing the passage of the distal end of the assembly shaft of the roller;
   a first clamping surface defining a portion of a contour of the opening, where the first clamping surface is configured for engaging with a first part of the radial outer surface of the assembly shaft of the roller;
   a first tightening hole passing through the plate and opening onto the rear surface;
a tightening part, intended to be positioned in the plate, and comprising:
   a second clamping surface facing the first clamping surface of the plate, where the second clamping surface is configured for engaging with a second part of the radial outer surface of the assembly shaft of the roller, where said second part is opposite the first part of the radial outer surface of the assembly shaft;
   a second tightening hole facing the first tightening hole of the plate;
a tightening member configured for passing through the second tightening hole of the tightening part, the first tightening hole of the plate, and a third tightening hole of the profile, where the tightening member serves to bring the plate and the tightening part closer along an approach direction;
   where either the plate or the tightening part comprises an inclined ramp, and the other comprises a sliding portion configured for engaging with the ramp, such that tightening of the tightening member induces the second clamping surface to approach the first clamping surface of the plate along a tightening direction until clamping the assembly shaft of the roller.

Thus, the proposed solution has, among other advantages, the advantage of being quicker and easier to assemble onto the profile than the existing solutions. In fact, assembly of the device is easy to do because it comprises only two parts, attached to each other and which may be tightened by the tightening member, such as a tightening screw. In particular, the tightening member, in particular the tightening screw, performs both the function of holding the device on the profile and the function of tightening the assembly shaft of the roller. The attachment device may thus comprise a single such tightening member, in particular a single tightening screw.

Further, the proposed solution demonstrates better reliability. With the device, the clamping of the assembly shaft of the roller can be assured without additional adjustment. In fact, the engagement between the ramp and the sliding portion tightens which reduces the probability of forming play near the holding of the roller.

Further, when the end of the roller that is to be secured is equipped with a cable provided with a connector, the opening arranged in the plate serves to assure the passage of the cable and connector without damaging them.

Further, the device, according to the present disclosure, is particularly cheap to produce because of the design thereof in only two parts.

Further, it becomes possible to tighten the assembly shaft and secure the device with a single attachment member, which may be the only one. The assembly time for such an attachment device comprising, according to an embodiment, a single attachment member, in particular a single tightening screw, is advantageously reduced.

The characteristics disclosed in the following paragraphs may, optionally, be implemented independently of each other or in combination with each other:

According to an example, the tightening member comprises a tightening screw engaging with a nut to bring the plate and the tightening part closer, where the ramp is inclined relative to the axis of the tightening screw.

According to an example, the ramp forms an angle with the approach direction included between 3° and 22°; preferably the angle of the ramp is substantially equal to 5° or substantially equal to 20°.

According to an example, the approach direction is perpendicular to the tightening direction.

According to an example, a portion of the opening of the plate is partially obstructed by the tightening part during tightening of the tightening member, such that once the tightening is done, the area of the obstructed portion of the opening represents at least 50% of the area of the opening.

According to an example, the plate comprises two lateral guiding walls extending at least partially between the first clamping surface and one or the other of the ramp or the sliding portion along the tightening direction, where the lateral guiding walls are configured for engaging with the lateral sides of the tightening part.

According to an example, the two lateral guiding walls each comprise a guiding rib having a stop surface extending perpendicularly to the approach direction, where a complementary stop surface of the tightening part is configured for engaging with the stop surface of the two guiding ribs of the plate so as to guide the tightening part and prevent it from separating from the profile during tightening of the tightening screw.

According to an example, the plate has a lateral passage through one of the lateral guiding walls, where the tightening part comprises a notch positioned such that the lateral passage of the plate opens on said notch of the tightening part when the tightening member, such that the tightening screw, is tightened.

According to an example, the assembly shaft of the roller has a hexagonal transverse section where the first clamping surface and the second clamping surface each comprise two opposite flats adjacent and inclined relative to each other.

According to an example, the first clamping surface and the second clamping surface each comprising a groove dug in both the plate and the tightening part, where each groove is positioned so that it extends instead of a shared edge of the two adjacent flats.

According to an example, the plate and the tightening part are made by injection of a metal or metal alloy, in particular an alloy comprising at least one metal selected from zinc, aluminum, magnesium or copper.

According to a second aspect, the present disclosure also relates to a conveyor comprising a profile and a roller comprising a cylindrical portion and an assembly shaft extending projecting from a flank of the cylindrical portion, where the assembly shaft comprises a distal end passing through the profile by a receiving opening, and where the roller is secured to the profile by an attachment device, as previously described.

According to an example, a channel opens into the distal end of the assembly shaft of the roller, where the roller comprises an electric cable provided with a connector which leaves the roller to the outside by said channel.

According to an example, the plate and the tightening part extend in length along a vertical direction, where the first part of the assembly shaft is an upper portion of the assembly shaft on which the first clamping surface of the plate rests by gravity when it is positioned against the profile, and the second part of the assembly shaft is a lower portion of the assembly shaft, where the tightening direction is along the vertical direction.

According to a third aspect, the present disclosure also relates to a method of attaching a conveyor roller on a profile with an attaching device, such as previously described, where the roller comprises a cylindrical portion and an assembly shaft extending projecting from a flank of the cylindrical portion, where the assembly shaft comprises a distal end passing through the profile by a receiving opening, and where the method comprises:
passing the assembly shaft of the roller through the receiving opening of the profile;
positioning the plate such that the first clamping surface engages with a first part of the radially outer surface of the assembly shaft of the roller, and such that the rear surface of the plate is pressed against the profile, and such that the first tightening hole is positioned facing the third tightening hole of the profile;
assembling the tightening part on the plate, by positioning the tightening part such that either the ramp or the sliding portion engages with the other of the ramp or the sliding portion, and such that the second tightening hole of the tightening part is facing the first tightening hole of the plate, and such that the second clamping surface is facing the first clamping surface such that the assembly shaft of the roller extends between the first clamping surface and the second clamping surface of the device;
passing a tightening screw through the first, second and third tightening holes;
tightening the tightening member, making the tightening part approach the plate such that a relative sliding between the sliding portion and the ramp brings the second clamping surface towards the first clamping surface of the plate until clamping the assembly shaft of the roller.

According to an example, the plate of the device comprises two lateral guiding walls, at least partially extending between the first clamping surface and one or the other of the ramp or the sliding portion, where the lateral guiding walls are configured for engaging with the lateral sides of the tightening part, where the method comprises, during assembly of the tightening part on the plate, inserting the tightening part between the two lateral guiding walls of the plate.

According to an example, the two lateral guiding walls each comprise a guiding rib having a stop surface extending parallel to the rear surface of the plate, where a complementary stop surface of the tightening part is configured for engaging with the stop surface of the two guiding ribs of the plate, where the method comprises, during insertion of the guiding part between the lateral guiding walls, passing the complementary stop surface under the stop surface of the guiding ribs of the plate.

### BRIEF DESCRIPTION OF THE DRAWINGS

Other characteristics, details and advantages will appear upon reading the following detailed description and upon analysis of the attached drawings, on which:

FIG. 1 shows in a first view 1A a schematic representation of a conveyor according to an example, then in a view 1B a representation seen from closer of an assembly shaft seen from the outside of the conveyor according to an example, corresponding to the zone circled in dashed lines in view 1A;

FIG. 2 shows a schematic front-view representation of an example of an attachment device according to the present disclosure, seen from the outside of the profile;

FIG. 3 shows a schematic front-view representation of a plate from the attachment device from FIG. 2;

FIG. 4 shows a schematic representation of a roller, a profile and the attachment device from FIG. 2 seen in section along a plane comprising the axis of the roller;

FIG. 5 shows a schematic representation of a plate and a tightening part from the attachment device from FIG. 2 seen in section along the plane A-A in a first view 5A and front view in a second view 5B;

FIG. 6 shows a schematic representation in perspective of a plate and a tightening part of the attachment device from FIG. 2, where the tightening part is inclined to be inserted in the plate;

FIG. 7 shows a schematic representation in perspective, seen from the outside of the profile, on which the assembly of the various parts making up the attachment device from FIG. 2 is seen;

FIG. 8 shows two schematic representations of a plate and a tightening part similar to those from views 5A and 5B from FIG. 5 on which the forces coming into play during tightening of the assembly shaft and during rotation of the roller can be seen, according to examples from the present disclosure; and

FIG. 9 shows the schematic representation of the attachment device from FIG. 2 seen in section along a plane comprising the axis of the roller, where the first view 9A shows a configuration before tightening of the attachment device, and view 9B shows a configuration in a final state, according to an example from the present disclosure.

### DETAILED DESCRIPTION

The following drawings and descriptions contain, for the most part, certain specific elements. They could therefore not only serve to make the present disclosure better understood, but also to contribute to its definition, as applicable.

In the various figures, the same references designate identical or similar items. For purposes of conciseness, only the elements which are useful for understanding the embodiment described are shown on the figures and are described in detail in the following.

In the following description, when referring to qualifiers of absolute position, such as the terms “front,” “rear,” “upper,” “lower,” etc., or to qualifiers of orientation, such as “horizontal,” “vertical,” etc., reference is made to the orientation of the figures unless otherwise stated. Further, the term “substantially” is interpreted as indicating that the result is obtained as precisely as the known method for measuring it.

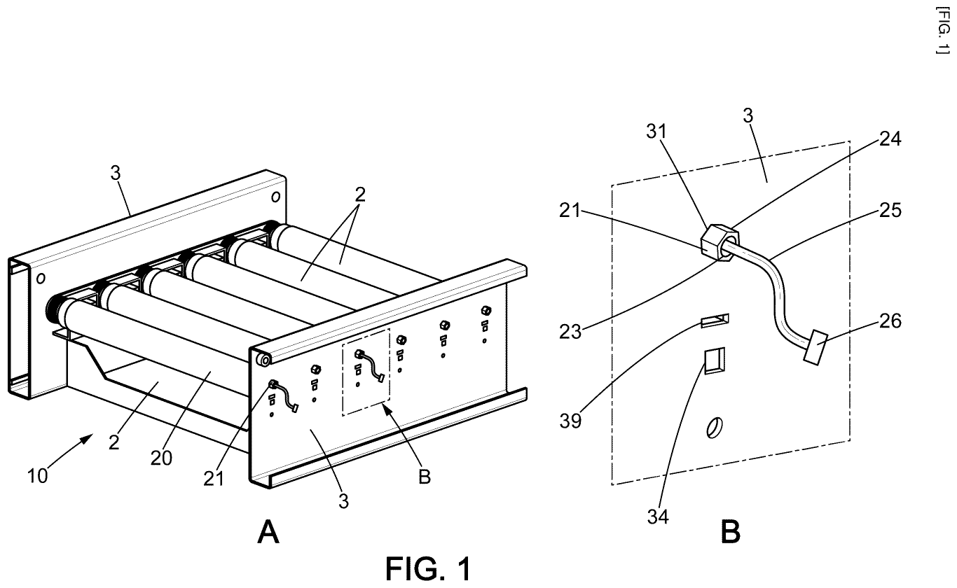

Now Referring to FIG. 1.

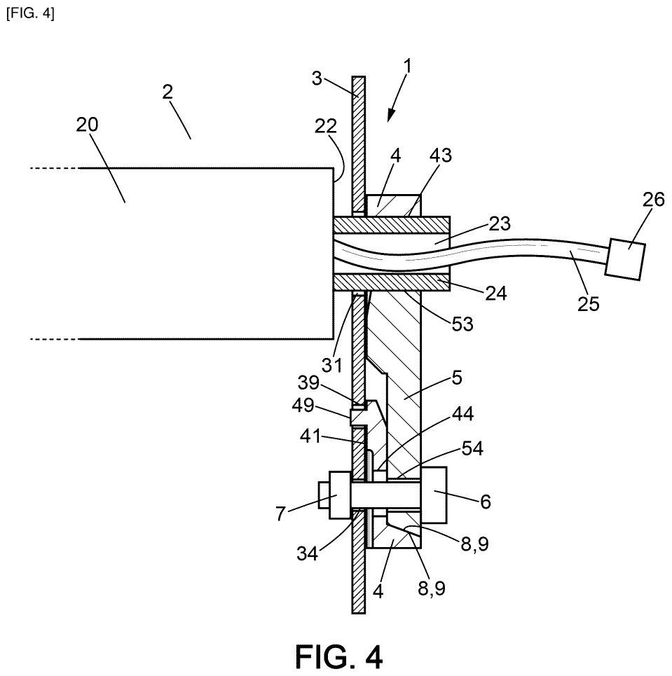

FIG. 1 shows a conveyor 10 on which a plurality of rollers 2 are assembled. The rollers 2 are assembled between two fixed, lateral profiles 3, facing each other. The profiles 3 are for example fixed to the ground (not shown) or to a fixed structure. Each roller 2 comprises a cylindrical portion 20 intended to allow merchandise to roll along a direction transverse to the rollers, in a volume located between the two profiles 3 and above the cylindrical portion 20 of the rollers 2. The cylindrical portion 20 is laterally closed by two lateral flanks 22 (FIG. 4). According to a configuration, these flanks 22 extend substantially parallel to the profiles 3 and substantially perpendicular to the axis of the roller 2.

The rollers 2 each also comprise an assembly shaft 21 which extends projecting from the two flanks 22 of the cylindrical portion 20. Each roller 2 comprises in particular a single assembly shaft 21 which passes through it over its entire length, and extends from each side of the roller, beyond these flanks 22. In other examples, each end of the roller 2 is provided with a specific assembly shaft 21.

According to the examples, the assembly shaft 21 comprises a channel 23 from which a cable 25 equipped with a connector 26 comes out. Such a connector is, in particular, present in a motorized roller 2. Typically, a conveyor 10 may comprise one or more rollers 2 whose rotation is driven by an actuator housed in said roller 2. The conveyor may then comprise a set of belts, linked to the actuated roller, and configured for transmitting said rotation to the other non-motorized rollers.

In the case of a roller comprising a cable 25, the assembly shaft 21 may comprise one first distal end to which the cable does not pass and one second distal end through which a channel is drilled to let the cable 25 to pass. Said cable 25 is typically connected to another connector, outside the roller 2, for example near a profile 3. In the example shown in FIG. 1, a cable 25 is shown at a distal end 24 of the assembly shaft 21 and is clearly visible in FIG. 1B. In an example, the channel 23 passes through the entire length of the assembly shaft 21 and thus also opens on the side from which the cable does not exit. In another example, the channel 23 does not extend from the side from which a cable does not pass, and in this case the distal end of the assembly shaft 21 is solid.

For conciseness of the description, unless otherwise mentioned, just one end of the cylinder is generally described, and it is understood that the other end has the same characteristics, for example, by symmetry around the transverse median plane of the cylindrical portion. A single cylinder is generally described, but it is understood that, depending on the examples, the conveyor also comprises other rollers having the same characteristics.

The assembly shaft 21 typically comprises one distal end 24 passing through the profile 3 by a receiving opening 31 housed in the profile 3. According to an example, and in particular such as shown in the figures, the assembly shaft is typically hexagonal and because of that, the receiving opening 31 has, at least over a major part of the contour thereof, a hexagonal shape. A first clamping of the rotation of the assembly shaft 21 relative to the profile 3 can be done with such an interlocking shape. Other receiving opening 31 and assembly shaft 21 shapes are conceivable, and this first rotational clamping is optional.

According to the examples, and in the case where one of the two ends of the assembly shaft 21 lets a cable 25 and the connector 26 thereof extend out, it can be provided that the receiving opening 31 is configured to allow the connector 26 and the cable 25 to pass. In particular, the receiving opening 31 has a dimension larger than that of the connector 26, which is typically larger than a diameter of the cable 25. According to a specific example, the receiving opening 31 is hexagonal over a major part of the contour thereof, then has a rectangular portion so as to increase the surface area formed by the opening while also allowing a first rotational clamping of the assembly shaft 21.

Once assembled on the profile 3, the cylindrical portion 20 of the roller 2 extends from a first side of the profile oriented towards the interior of the conveyor 10 and the distal end 24 of the assembly shaft 21 extends from a second side of the profile oriented towards the exterior of the conveyor 10. In the case where a cable passes through said end 24, this cable extends from an outer side of the profile 3.

According to the examples, the distal end 24 of the assembly shaft 21 may extend from the profile a distance included between 10 and 50 mm.

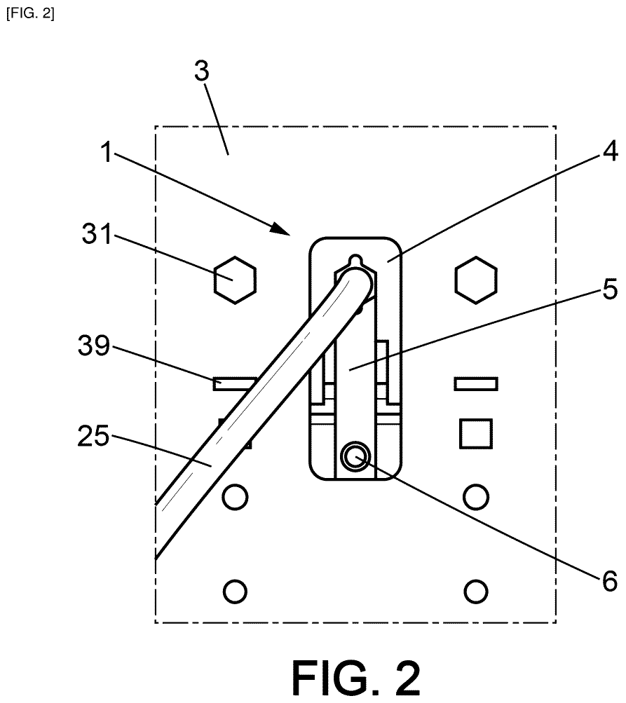

According to the present disclosure, the one or more rollers are held on the profiles 3 by an attachment device 1, an example of which is in particular shown in FIG. 2.

The attachment device 1, according to the present disclosure, comprises two main parts: a plate 4 and a tightening part 5. Each of the plate 4 or the tightening part 5 may be unitary, meaning of a single piece.

The plate 4 and the tightening part 5 may each be made by injection of a metal or metal alloy in a mold. In particular, the metal or the metal alloy comprises a metal selected from zinc, aluminum, magnesium, copper or a combination thereof. It is also possible that the plate 4 and/or the tightening part 5 are made of plastic.

As shown in FIG. 4, the plate 4 first comprises a rear surface 41 configured for resting against the profile 3. Generally, the rear surface 41 of the plate 4 is pressed against the profile from an outer side of the profile 3.

The plate 4 further comprises an opening 42 configured for allowing the passage of the distal end 24 of the assembly shaft 21 of the roller 2. The opening passes through the plate from side to side, in particular from front to rear, and opens to the rear of the plate by the rear surface 41.

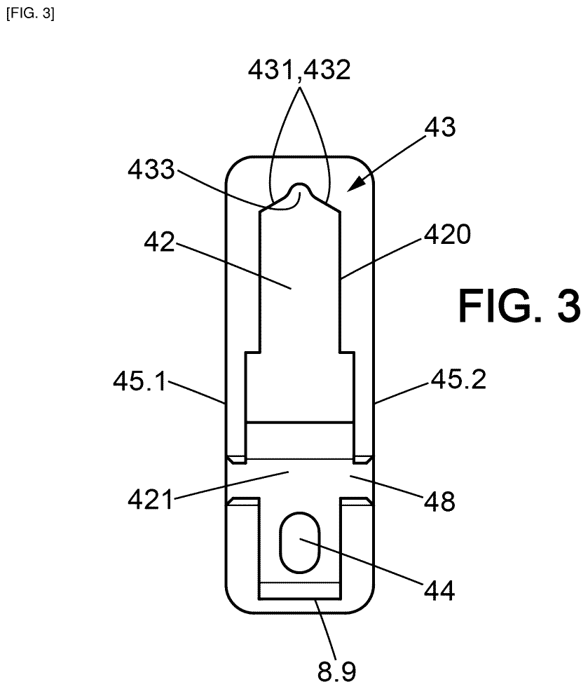

Depending on the case, a cable 25 provided with a connector 26 may pass through the channel 23 of the assembly shaft 21 and in that case, the opening 42 is, in particular, sized to allow the passage of the connector 26. An example of an attachment device 1 is shown in FIG. 3 in which the opening 42 is specifically visible.

The plate 4 also comprises a first clamping surface 43, defining a limit of the opening 42, preferably an upper limit of the opening 42 when the plate is positioned vertically. The first clamping surface 43 has a shape which allows it to engage with the radially outer surface 210 of the assembly shaft 21.

Generally, the first clamping surface 43 is configured for engaging with a first part 211 of the radially outer surface 210 of the assembly shaft 21 of the roller 2.

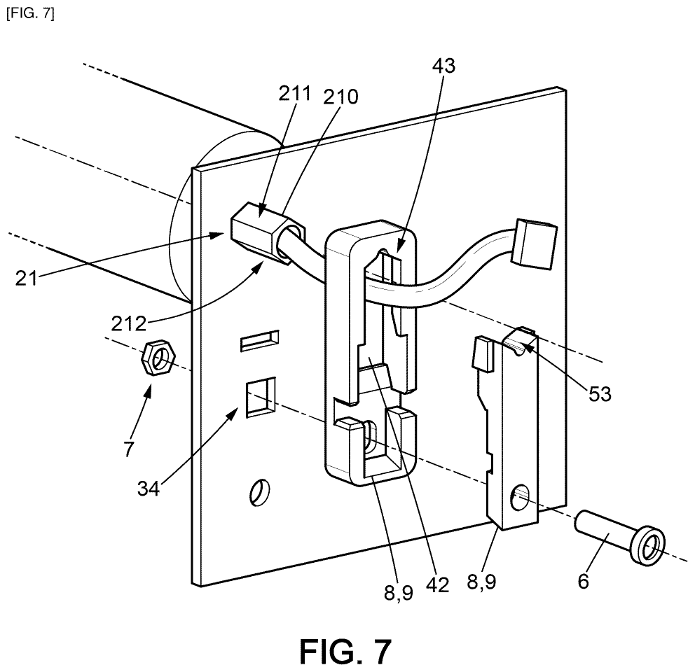

According to an example, this first part 211 is an upper part of the assembly shaft 21, in particular according to the example shown in FIG. 7. In particular, the assembly shaft 21 may comprise a first upper part and a second lower part, delimited by a median horizontal plane of the assembly shaft 21. The first upper part being oriented upward when the conveyor 10 is placed on the ground in normal position for use, and the second lower part being oriented downward. In such a configuration, the first clamping surface 43 is configured for engaging, for example by interlocking shapes, with the first upper part of the assembly shaft 21.

Further, the plate 4 comprises a first tightening hole 44 through the plate 4 and opening onto the rear surface 41. According to an example, the first tightening hole 44 may be a portion of the opening 42. In other words, the opening 42 may extend so far as to include said first tightening hole 44. Stated differently, according to the examples, the first tightening hole 44 and the opening 42 are not separated by the material constituting the plate 4 and form a single opening.

According to a specific example, and in particular as shown in FIGS. 3 and 7, the plate 4 may comprise a bottom 421, on which and through which the first tightening hole 44 is arranged. In this case, the opening 42 and the first tightening hole 44 are distinct. The bottom 421 may serve to make the positioning of the tightening part 5 in the plate easier by preventing the tightening part from passing through the opening 42 of the plate.

Other than the plate 4, the device 1 comprises a tightening part 5. This tightening part 5 is typically distinct from the plate 4.

The tightening part 5 is intended to be positioned on or in the plate 4. For this purpose, the plate 4 may comprise a housing sized to be able to receive the tightening part 5. According to an example, such a housing may comprise two lateral guiding walls 45.1 and 45.2, which laterally delimit the housing of the tightening part 5. The tightening part may then have lateral sides 55.1, 55.2 substantially separated by a distance slightly less than that which separates the two lateral guiding walls of the plate 4.

According to an example, the lateral guiding walls 45.1, 45.2 extend on both sides of the opening 42.

The tightening part 5 comprises a second clamping surface 53 which, when the tightening part 5 is positioned in the plate 4, is located facing the first clamping surface 43 of the plate 4. In fact, the second clamping surface 53 is configured for engaging with a second part 212 of the radially outer surface 210 of the assembly shaft 21 of the roller 2, where said second part 212 is opposite the first part 211 of the radially outer surface 210 of the assembly shaft 21. By “opposite” it is understood that the first and second parts 211, 212 of the assembly shaft 21 are positioned such that the forces exerted on them by the first and second clamping surfaces 43, 53 cancel and hold the assembly shaft “sandwiched” between the plate 4 and the tightening part 5. It is therefore acceptable that the first clamping surface and the second clamping surface may not have the same shape, nor even be symmetric to each other about a median horizontal plane.

According to an example, the plate 4 may have a thickness less than the distance by which the assembly shaft 21 extends past the profile 3 in particular near the first clamping surface 43. In this way, when the plate 4 is pressed against the profile, and the assembly shaft 21 passes through the opening 42, a portion of the assembly shaft 21 extends beyond the plate towards the outside of the conveyor 10. In this way, it is guaranteed that a sufficient portion of the assembly shaft is held between the clamping surfaces 43, 53 of the plate 4 and the tightening part 5.

According to an example, this second part 212 is a lower part of the assembly shaft 21. In particular, when the first clamping surface 43 is configured for engaging with an upper part of the assembly shaft 21 then the second clamping surface 53 of the tightening part is configured for engaging with a lower part of the assembly shaft 21. In this way, the forces produced by these surfaces on the assembly shaft 21 cancel during tightening to achieve the clamping of the assembly shaft 21, for example in a manner comparable to that of a chuck.

According to an example, the first clamping surface 43 and the second clamping surface 53 have, between them, at least three points bearing on the assembly shaft 21 so as to guarantee clamping of the assembly shaft 21 in all directions. In particular, and as in the example shown in the figures, they have four bearing points, made up by four surfaces bearing on the shaft. Other configurations are of course possible.

The tightening part 5 further comprises a second tightening hole 54 passing through the tightening part from one side to the other, typically from front to back. When the tightening part 5 is positioned in the plate 4, the second tightening hole 54 is configured for being positioned facing the first tightening hole 44 of the plate 4.

For this purpose, when the plate 4 comprises lateral guiding walls 45.1, 45.2 which laterally delimit the housing of the tightening part 5, the first tightening hole 44 of the plate may be centered at equal distance laterally from the two lateral guiding walls 45.1, 45.2; similarly, the second tightening hole 54 may be positioned at equal distance from the two lateral sides 55.1, 55.2 of the tightening part 5, to guarantee an alignment of the two holes relative to each other.

Further, the attachment device 1 comprises a tightening member 6 configured for passing through the second tightening hole 54 of the tightening part 5, the first tightening hole 44 of the plate 4, and a third tightening hole 34 of the profile 3. According to an example, and in particular as shown in the figures, the tightening member is inserted by an outer side of the profile 3 so as to pass first through the tightening part 5, next through the plate 4, then finally through the profile 3 until exiting on an inner side of the profile 3. It is of course also possible to insert the tightening member 6 from an inner side of the profile 3. The tightening member 6 is configured for bringing the tightening part 5 and the plate 4 closer to each other along an approach direction; in particular, the approach direction may be parallel to the direction of elongation of the assembly shaft 21.

The device, according to the present disclosure, is particularly advantageous in that it is both fixed to the profile and tightened by a single tightening member.

“Tightening member” is understood to mean any element or mechanism with which to bring the two opposite surfaces closer to each other, coming closer to each other along a single through part, for example, having the shape of a rod. Said tightening member 6, in an example of the present disclosure, may be configured for bringing a first tightening surface, for example brought by a screw head in contact with the tightening part, closer to a second tightening surface, for example brought by a nut in contact with the profile 3, along the shank of the screw. According to the present disclosure, the tightening member 6 may be made up of a single part (for example a screw engaging with threads in the profile), or even of just two parts (for example a screw and a nut, or even a quick fastening mechanism comprising a rod provided with a stop and a rotary tightening head comprising an eccentric portion).

It is thus possible, without going outside the scope of the present disclosure, to add other members, for example for attachment to hold the plate 4 to the profile 3.

According to the present disclosure, the tightening member 6 may comprise a single through part, penetrating the first, second and third tightening hole. The tightening member may comprise other parts engaging with this single through part so as to form two surfaces coming towards each other, causing a tightening part 5 to come towards the plate 4.

Either the plate 4 or the tightening part 5 further comprises an inclined ramp 8 serving to accompany the approach of the tightening part 5 towards the plate 4 for a translational movement of the tightening part 5 towards the assembly shaft 21. For this purpose, the other of the plate or the tightening part comprises a sliding portion 9 configured for engaging with the ramp 8, such that tightening of the tightening member 6 induces the second clamping surface 53 to approach the first clamping surface 43 of the plate 4 along a tightening direction until clamping the assembly shaft 21 of the roller 2.

According to an example, the plate 4 remains immobile during the tightening action, with the first clamping surface 43 is already in contact with the assembly shaft 21. In fact, in this case, it is the tightening part 5 which is moved in translation along the tightening direction, and only the second clamping surface 53 moves by getting closer to the first clamping surface 43 which remains immobile.

According to a configuration in which the plate extends vertically in length, the tightening direction is vertical and that tightening part 5 coming closer relative to the plate 4 is horizontal, along the direction of elongation of the assembly shaft. This is the case in particular in the nonlimiting example shown in the figures.

When the tightening member comprises a screw, or a rod passing through the tightening holes, the ramp is inclined relative to the axis of the screw, or the axis of the rod as applicable.

According to an example, considering “low” as being near the profile 3 and “high” as being away from the profile 3 when the device is assembled on the conveyor 10, a high point of the ramp 8 is farther from the second clamping surface 53 than a low point of the ramp 8 such that by sliding from a high point to a low point of the ramp 8 while approaching the plate 4, the tightening part 5 slowly comes towards the assembly shaft 21 of the roller 2, while the second clamping surface 53 then approaches the first tightening surface 43 causing a tightening force on the assembly shaft 21 sandwiched between the two.

According to the examples, it is possible that the ramp 8 is a first ramp and that the sliding portion 9 comprises a second ramp in addition to the first ramp 8. A greater tolerance for the dimensions of the plate in the tightening part can in particular be allowed with such a configuration. The presence of a first ramp and a second additional ramp may in particular allow reducing the contact pressure between these two parts and therefore limiting deformation thereof. Such an example is in particular shown in the figures. In this case, the first ramp and the second ramp may have an identical angle of inclination.

According to other examples, the sliding portion 9 may be an edge, a fillet or a chamfer, or even an arbitrary rounding, possibly having arrangements useful for reducing friction between the two parts, for example a local reduction of the contact surface area or a suitable coating.

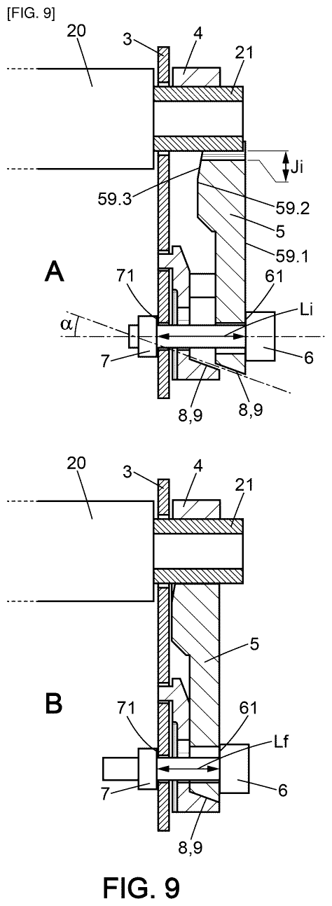

According to an example, the ramp forms and angle α with the axis of the screw or of the rod that is included between 3° and 22°. Preferably, the angle of the ramp is substantially equal to 5° or substantially equal to 20°. According to the configuration, it is possible that a smaller angle, here, for example, 5°, gives the assembly more stability, such that it would even be possible to maintain satisfactory clamping after having withdrawn the tightening member 5. This can also lead to further difficulties withdrawing the tightening member, which can become clamped between the plate 4 and the assembly shaft 21. Conversely, it is possible that a higher angle, here 20° for example, gives greater flexibility, such that the tightening part 5 is easier to withdraw from the plate 4 once tightened. The angle α between the tightening member 6 and the ramp 8 is specifically visible in FIG. 9 according to an example.

Generally, the plate 4 comprises a contour 420 at least a portion of which delimits the opening 42. According to an example, the shape of this contour is rectangular. In assembly position, the length of this contour may extend vertically, such that the width thereof is measured horizontally. According to an example, the length thereof is larger than the width thereof; for example, the length thereof is at least two times larger than the width thereof.

According to an example, this contour 420 extends projecting perpendicularly to the rear surface 41 of the plate, and the interior of this contour 420 delimits a housing intended to receive the tightening part 5. As previously described, according to an example, such a contour may have lateral guiding walls 45.1, 45.2 able to guide the lateral sides 55.1, 55.2 of the tightening part 5 along the tightening direction.

According to a configuration, the contour 420 may comprise a small upper side, which comprises the first clamping surface 43, two large lateral sides, which may, as necessary, comprise lateral guiding walls 45.1, 45.2 and a small lower side comprising typically one or the other of the ramp 8 or the sliding portion 9. According to this configuration, during positioning thereof, it is possible for the plate 4 to be suspended vertically on the assembly shaft 21 by the first clamping surface 43 and to extend naturally by gravity downward, such that the first tightening hole 44 is naturally located facing the third tightening hole 34 of the profile 3 laid out for being aligned vertically with the receiving opening of the assembly shaft 21. In this way, an operator who assembles such a plate is not constrained to keep the plate 4 in position on the profile 3 with their hand for example while they bring up the tightening part 5.

Other configurations are of course possible in which the plate extends for example horizontally relative to the assembly shaft 21 or for example vertically upward. The plate 4 may additionally have a general shape other than a rectangular shape.

According to an example, the tightening part 5 extends in length along a generally rectangular shape oriented vertically, having a lower small side on which is arranged the other rampant 8 or the sliding portion 9, two large lateral sides configured as necessary for engaging with lateral guiding walls 45.1, 45.2 of the plate, and an upper small side on which the first clamping surface 53 is provided. More generally, according to the examples, independent of the general shape of the tightening part, the ramp 8 or sliding portion 9 borne by the tightening part 5 is located on a side opposite to that which has the second clamping surface 53.

Further, the ramp or sliding portion is located at a distance included between 25 mm and 85 mm from the second clamping surface 53.

According to the examples, the second tightening hole 54 is laid out, in the tightening part 5, between the second clamping surface 53 and that of the ramp 8 or the sliding portion 9 which is borne by the tightening part 5.

According to an example, the second tightening hole 54, a median plane of either the ramp 8 or the sliding portion 9, and the median plane of the second clamping surface 53 are aligned along the tightening direction.

According to an example, the second tightening hole 54 is positioned on the tightening part near the ramp 8 or the sliding portion 9 in the sense that it is closer to the ramp 8 or the sliding portion 9 than the second clamping surface 53.

A similar configuration is possible for the plate 4, in which the first tightening hole 44 may be arranged, in the plate 4, between the first clamping surface 43 and that of the ramp 8 or of the sliding portion 9 which is borne by the plate 4.

According to an example, the first tightening hole 44, a median plane of the other of the ramp 8 or the sliding portion 9, and the median plane of the first clamping surface 43 are aligned along the tightening direction.

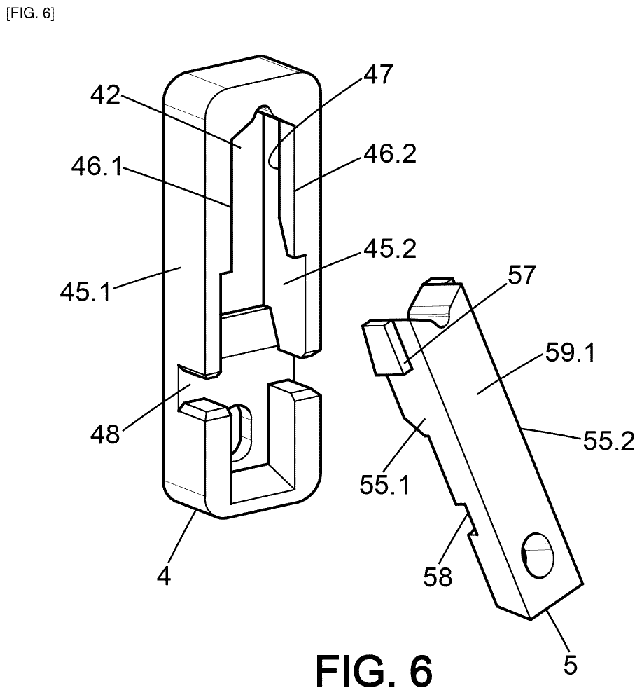

According to an example, in particular as shown in FIG. 6, the plate 4 comprises two lateral guiding walls 45.1, 45.2 extending at least partially between the first clamping surface 43 and one or the other of the ramp 8 or the sliding portion 9 along the tightening direction. The lateral guiding walls 45.1, 45.2 may then engage with the lateral sides 55.1, 55.2 of the tightening part 5.

According to an example, the first tightening hole 44 is positioned on the plate 4 near the ramp 8 or the sliding portion 9 in the sense that it is closer to the ramp 8 with the sliding portion 9 than the first clamping surface 43.

According to an example, concerning one or the other of the plate 4 or the tightening part 5, the ramp 8 or the sliding portion 9 is arranged at a distance included between 25 and 85 mm from the first or second clamping surface 43, 53. According to an example, concerning one or the other of the plate 4 or the tightening part 5, the first or the second tightening hole 44, 54 is arranged at a distance less than 30 mm from the ramp 8 or from the sliding portion 9.

According to an example, the two lateral guiding walls 45.1, 45.2 each comprise a guiding rib 46.1, 46.2 having a stop surface 47 extending perpendicularly to the axis of the tightening screw 6 parallel to the rear surface 41 of the plate 4, where a complementary stop surface 57 of the tightening part 5 is configured for engaging with the stop surface 47 of the two guiding ribs 46.1, 46.2 of the plate 4 so as to guide the tightening part 5 and prevent it from separating from the profile 3 during tightening of the tightening screw 6.

According to an example, the stop surface 47 of each of the guiding ribs 46.1, 46.2 of the plate 4 is oriented downward, in other words, towards the profile 3 whereas the complementary stop surface 57 of the tightening part 5 is oriented upward, in other words, towards the outside of the conveyor 10. Their complementarity allows in particular a hold of the tightening part 5 in the plate 4.

In particular, the plate 4 may have a lateral passage 48 which may go through the contour 420 and/or one of the lateral guiding walls 45.1, 45.2. In this case, the tightening part 5 may comprise a notch 58 positioned such that the lateral passage 48 of the plate 4 opens onto said notch 58 from the tightening part 5 when the tightening member 6 is tight. In this way, a tool may be used for reaching the notch 58 of the tightening part 5, made accessible by the lateral passage 48 so as to dislodge the tightening part 5 preferably after having loosened the tightening member 6. According to an example, the attachment device 1 comprises two lateral passages 48 and two notches 58.

According to an example and in particular such as shown in FIG. 3, in which the plate 4 comprises a bottom 421, the bottom may serve to stiffen the plate 4 by binding the two large lateral sides and the lower side of the contour 420 of the plate. According to an example, a low point of the ramp constitutes a lower edge of the bottom 421.

According to the example shown in particular in FIGS. 4, 7 and 9, the tightening member is a screw engaging with a nut.

According to an example, the nut is an added part provided with a thread. According to other examples, the nut is a thread laid out in the hole of the profile 3 or even a thread laid out in a part attached to the profile, for example welded to the profile.

Generally, the nut 7 is positioned on a first side oriented towards the inside of the profile 3 and the screw 6 is inserted from a second side oriented towards the outside of the profile. That said, proceeding in the opposite way is not excluded.

According to an example, the first tightening hole 44 of the plate 4 and the second tightening hole 54 of the tightening part 5 are oblong. In a configuration where the attachment device 1 extends vertically, the holes 44, 54 have a length along the vertical direction which is larger than their width. Generally, the holes 44, 54 are oblong in the tightening direction.

According to an example, the first tightening hole 44 of the plate has a greater length than that of the tightening part 5 along the tightening direction, so as to absorb the sliding of the tightening part 5 along the plate 4 during tightening of the tightening member 6.

According to an example, a portion of the opening 42 of the plate 4 is partially obstructed by the tightening part 5 during tightening of the tightening member 6, such that once the tightening is done, the area of the obstructed portion of the opening 42 represents at least 50% of the area of the opening 42. Such a configuration serves to design an opening 42, which is particularly large, so as to guarantee the passage of a connector 26 if the roller 2 comprises a cable 25.

According to an example, in particular in which the plate 4 extends vertically, the assembly shaft 21 occupies an upper portion of the opening 42, and a lower portion of the opening 42 is blocked by the tightening part 5. In this case, the lower portion is larger than the upper portion of the opening 42.

According to a specific example, the plate 4 comprises a key 49 extending transversely to the plate 4 for example in the width of the plate along a horizontal direction. The key 49 may be jointly molded with the plate 4 and extend projecting from the rear surface 41 thereof. The key 49 is thus configured for engaging with a slot 39 provided in the profile 3 during the assembly of the plate 4 against the profile 3. In fact, the slot 39 may have a shape complementary to the key 49, typically a rectangular punch out, making a window slightly larger than the key 49, such that the key 49 may enter the slot 39 and provide additional bearing of the plate 4 on the profile 3. Such a key 49 may, in particular, contribute to holding the attachment device 1 in position during tightening of the tightening member 6.

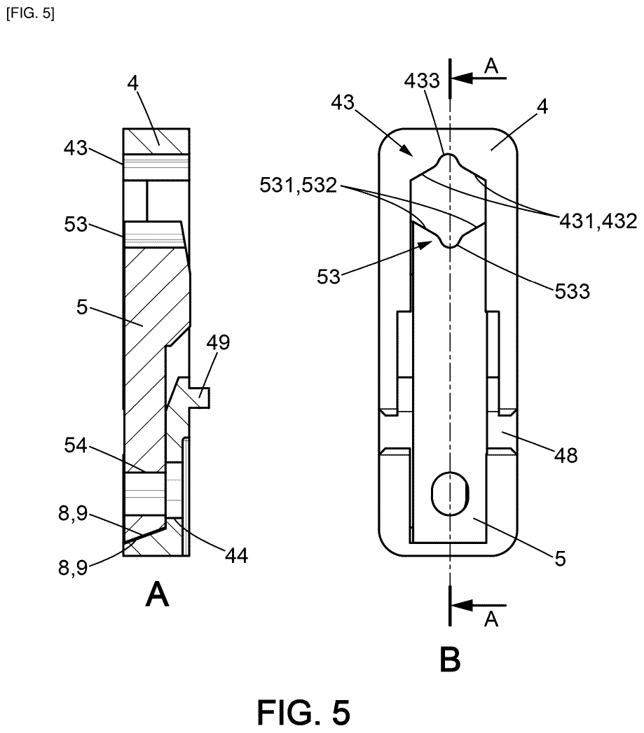

According to an example, the first clamping surface 43 and the second clamping surface 53 each comprise two adjacent flats 431, 432, 531, 532 that are opposite. Such a configuration is specifically visible in FIG. 5 according to an example.

According to other examples, one of the first clamping surface 43 and the second clamping surface 53 comprise a horizontal flat, and the other comprises two inclined flats. Independent of the arrangement thereof, the flats make a surface contact with the assembly shaft 21 which serves to distribute the forces and minimize the wear on the shaft 21 which could be caused by the tightening force.

According to other examples, the clamping surfaces 43, 53 do not comprise flats, but projecting edges or have a fillet, configured for bearing linearly on the assembly shaft 21. The bearing surfaces thus formed extend along the direction parallel to the axis of the roller 2. Such a configuration allows the attachment device 1 to engage with various assembly shaft 21 shapes, for example with a cylindrical shaft of revolution.

According to a configuration, particularly in which the plate 4 extends vertically, the first clamping surface 43 comprises a vertex forming an angle between two inclined flats extending laterally downward from said vertex. In this way, the two inclined flats form the upper portion of the hexagon and may engage with a hexagonal assembly shaft. Further, this configuration has the advantage of naturally centering the plate 4 on the conveyor 10, with the first clamping surface 43 coming first to position itself centered on the assembly shaft 21 by engagement between the shapes of the two parts.

According to a specific example, the first clamping surface 43 and the second clamping surface 53 each comprise a groove 433, 533 dug in both the plate 4 and the tightening part 5 instead of the shared edge of the two adjacent inclined flats 431, 432, 531, 532. In particular, the groove may have a rounded bottom. Such a groove serves to minimize the concentration of stress near the angle formed by the two flats.

Now referring to FIG. 7 which more specifically shows an example of an assembly method according to the present disclosure. In fact, the method comprises, first, passing the assembly shaft 21 of the roller 2 through the receiving opening 31 of the profile. According to an example, and as was previously described, there may be interlocking shapes between the receiving opening 31 and the assembly shaft 21 which then allows a first rotational clamping of the shaft, and optionally also allows guiding the shaft in a particular angular position. According to an example, the shape of the receiving opening 31 is configured for guiding the assembly shaft 21 such that it has, in its upper portion, a vertex connecting two inclined flats extending laterally downward, as is the case in the example shown in FIG. 7.

After passing the assembly shaft 21, the plate 4 is positioned such that the first clamping surface 43 engages with a first part 211 of the radially outer surface 210 of the assembly shaft 21 of the roller 2. Further, the rear surface 41 of the plate is pressed against the profile 3. The plate 4 is also positioned such that the first tightening hole 44 is positioned facing the third tightening hole 34 of the profile 3. According to an example previously described, the first part 211 of the radially outer surface 210 of the assembly shaft 21 is an upper portion of the shaft, and the plate 4 is thus suspended on the shaft 21 so as to extend vertically downward. According to such a configuration, the plate is naturally positioned, by gravity, such that the first tightening hole 44 falls facing the third tightening hole 34. For this purpose, the third tightening hole 34 is arranged in the profile 3 such that it is vertically aligned under the receiving opening 31.

After the positioning of the plate, or before the positioning thereof, the tightening part 5 is assembled on or in the plate 4 such that either the ramp 8 or sliding portion 9 engages with the other of the ramp 8 or sliding portion 9. The tightening part 5 is also positioned such that the second tightening hole 54 is facing the first tightening hole 44 of the plate 4 and such that the second clamping surface 53 is facing the first clamping surface 43. In this way, the assembly shaft 21 of the roller 2 extends between the first clamping surface 43 and the second clamping surface 53 of the attachment device.

Once the plate 4 and the tightening part 5 are assembled on the conveyor, the tightening member 6 is passed, preferably from an outer side of the profile 3, through the second tightening hole 54 then the first tightening hole 44 and finally the third tightening hole 34. Passage in the opposite order is possible if the tightening member 6 is inserted by an inner side of the profile 3.

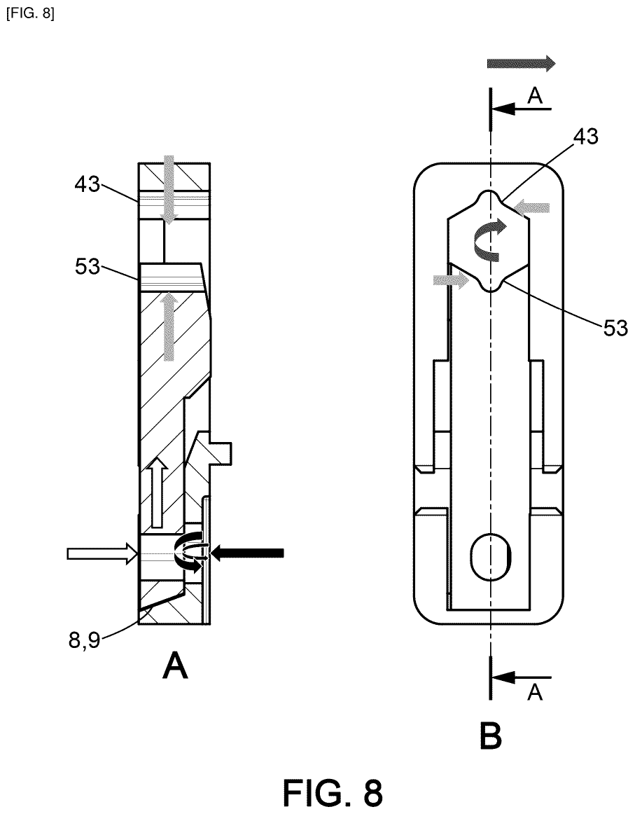

The tightening member 6 is then tightened, making the tightening part 5 approach the plate 4 such that a relative sliding between the sliding portion 9 and the ramp 8 brings the second clamping surface 53 towards the first clamping surface 43 of the plate 4 until clamping the assembly shaft 21 of the roller 2. The distribution of the forces and the effect of the engagement between the ramp 8 and the sliding portion 9 is in particular shown in FIG. 8a. The resisting torque induced on the assembly shaft 21 by the tightening of the two clamping surfaces 43, 53 is shown in FIG. 8b.

During this tightening action, the tightening member 6 has an initial length “Li” between, on the one hand, the outer contact surface 61 between the tightening member 6 and the front surface 59.1 of the tightening part 5 and, on the other, the inner contact surface 71 between the tightening member 6 and the inner side of the profile 3; and there is a nonzero initial play “Ji” between the second clamping surface 53 and the assembly shaft 21, such as shown, as an example, in view 9a from FIG. 9. The tightening action serves to reduce the initial length of the tightening member 6 down to a final length “Lf”. The length of the tightening member 6 thus goes from “Li” to “Lf”, with Lf<Li. The engagement between the ramp 8 and the sliding portion 9 serves to bring the second clamping surface 53 for the assembly shaft 21 closer until eliminating the play between the two elements which, at the end of tightening, are tightened in contact against each other, such as shown as an example in view 9b from FIG. 9.

On this FIG. 9, the tightening part 5 is shown in a “theoretical” position which seems to interfere with the plate in cases where the plate comprises guiding ribs, for example, such as previously described. It will be understood that the position of the tightening part 5 may also be inclined relative to the plate 4.

In cases according to which the roller 2 comprises an electric cable 25 provided with a connector 26 exiting to the outside of the roller 2 comprising a channel 23 opening from the distal end 24 of the assembly shaft 21 of the roller 2, the method includes, before positioning of the plate,
passing the connector 26 and cable 25 through the receiving opening 31 of the profile; and
passing the connector 26 and cable 25 through the opening 42 of the plate 4.

According to an example in which the plate 4 comprises two lateral guiding walls 45.1, 45.2, the method may comprise, during assembly of the tightening part 5 onto the plate 4, inserting the tightening part 5 between the two lateral guiding walls 45.1, 45.2 of the plate 4. Thus, the tightening part 5 is held laterally in a housing provided in the plate 4, so as to center the tightening part 5 on the plate 4. In this way, the risk is also limited that the second tightening hole 54 of the tightening part 5 becomes offset laterally from the first tightening hole 44 of the plate 4.

According to a specific example in which the two lateral guiding walls 45.1, 45.2 each comprise a guiding rib 46.1, 46.2, the method may comprise, during insertion of the tightening part 5 between the guiding lateral walls 45.1, 45.2, passing the additional stop surface 57 under the stop surface 47 of the guiding ribs 46.1, 46.2 of the plate 4. For this purpose, the tightening part 5 may be inclined during insertion thereof into the plate, as shown for example in FIG. 6, so as to present, first, an upper portion of the tightening part 5 comprising the second clamping surface 53 and the additional stop 57, so as to slide under the guiding ribs 46.1, 46.2.

For example, the additional stop surface 57 may be borne by two lateral extensions projecting from the lateral sides 55.1, 55.2 of the tightening part 5. In other examples, the additional stop surface 57 is made up by a portion of the front surface 59.1 of the tightening part 5. Preferably, the additional stop surface is arranged near the second clamping surface 53 in an upper portion of the tightening part 5.

According to a specific example, in particular visible in FIG. 9, a rear surface 59.2 of the tightening part may have, in a zone adjacent to the second clamping surface 53, a chamfer 59.3 which withdraws material from the tightening part 5. According to an application, such a chamfer 59.3 may make the insertion of the tightening part 5 under the guiding ribs 46.1, 46.2 of the plate 4 easier, by removing material which could, by the inclination of the tightening part 5, come to interfere with the profile 3 and prevent the passage of the guiding part 5.

1. A device for attachment of a conveyor roller on a profile, where the roller comprises a cylindrical portion and an assembly shaft extending projecting from a flank of the cylindrical portion, where the assembly shaft comprises a distal end passing through the profile by a receiving opening, and where the attachment device comprises:
a plate, comprising:
a rear surface configured for resting against the profile;
an opening configured for allowing the passage of the distal end of the assembly shaft of the roller;
a first clamping surface defining a portion of a contour of the opening, where the first clamping surface is configured for engaging with a first part of the radial outer surface of the assembly shaft of the roller;
a first tightening hole passing through the plate and opening onto the rear surface;
a tightening part, intended to be positioned in the plate, and comprising:
a second clamping surface facing the first clamping surface of the plate, where the second clamping surface is configured for engaging with a second part of the radial outer surface of the assembly shaft of the roller, where said second part is opposite the first part of the radial outer surface of the assembly shaft;
a second tightening hole facing the first tightening hole of the plate;
a tightening member configured for passing through the second tightening hole of the tightening part, the first tightening hole of the plate, and a third tightening hole of the profile, where the tightening member serves to bring the plate and the tightening part closer along an approach direction;
where either the plate or the tightening part comprises an inclined ramp, and the other comprises a sliding portion configured for engaging with the ramp, such that tightening of the tightening member induces the second clamping surface to approach the first clamping surface of the plate along a tightening direction until clamping the assembly shaft of the roller.

2. The attachment device according to claim 1, wherein the tightening member comprises a tightening screw engaging with a nut to bring the plate and the tightening part closer, where the ramp is inclined relative to the axis of the tightening screw.

3. The attachment device according to claim 1, wherein the ramp forms an angle with the approach direction included between 3°and 22°; preferably the angle of the ramp is substantially equal to 5° or substantially equal to 20°.

4. The attachment device according to claim 1, wherein a portion of the opening of the plate is partially obstructed by the tightening part during tightening of the tightening member, such that once the tightening is done, the area of the obstructed portion of the opening represents at least 50% of the area of the opening.

5. The attachment device according to claim 1, wherein the plate comprises two lateral guiding walls extending at least partially between the first clamping surface and one or the other of the ramp or the sliding portion along the tightening direction, where the lateral guiding walls are configured for engaging with the lateral sides of the tightening part.

6. The attachment device according to claim 5, wherein the two lateral guiding walls each comprise a guiding rib having a stop surface extending perpendicularly to the approach direction, where a complementary stop surface of the tightening part is configured for engaging with the stop surface of the two guiding ribs of the plate so as to guide the tightening part and prevent it from separating from the profile during tightening of the tightening screw.

7. The attachment device according to claim 1, wherein the assembly shaft of the roller has a hexagonal transverse section where the first clamping surface and the second clamping surface each comprise two opposite flats adjacent and inclined relative to each other.

8. The attachment device according to claim 7, wherein the first clamping surface and the second clamping surface each comprising a groove dug in both the plate and the tightening part, where each groove is positioned so that it extends instead of a shared edge of the two adjacent flats.

9. A conveyor comprising the profile and a roller comprising a cylindrical portion and an assembly shaft extending projecting from a flank of the cylindrical portion, where the assembly shaft comprises a distal end passing through the profile by receiving opening, where the roller is attached to the profile by an attachment device according to claim 1.

10. The conveyor according to claim 9 wherein the plate and the tightening part extend in length along a vertical direction, where the first part of the assembly shaft is an upper portion of the assembly shaft on which the first clamping surface of the plate rests by gravity when it is positioned against the profile, and the second part of the assembly shaft is a lower portion of the assembly shaft, where the tightening direction is along the vertical direction.

11. A method for attachment of a conveyor roller on a profile with an attachment device according to claim 1, where the roller comprises a cylindrical portion and an assembly shaft extending projecting from a flank of the cylindrical portion, where the assembly shaft comprises a distal end passing through the profile by a receiving opening, and where the method comprises:
passing the assembly shaft of the roller through the receiving opening of the profile;
positioning the plate such that the first clamping surface engages with a first part of the radially outer surface of the assembly shaft of the roller, and such that the rear surface of the plate is pressed against the profile, and such that the first tightening hole is positioned facing the third tightening hole of the profile;
assembling the tightening part on the plate, by positioning the tightening part such that either the ramp or the sliding portion engages with the other of the ramp or the sliding portion, and such that the second tightening hole of the tightening part is facing the first tightening hole of the plate, and such that the second clamping surface is facing the first clamping surface such that the assembly shaft of the roller extends between the first clamping surface and the second clamping surface of the attachment device;
passing a tightening screw through the first, second and third tightening holes;
tightening the tightening member, making the tightening part approach the plate such that a relative sliding between the sliding portion and the ramp brings the second clamping surface towards the first clamping surface of the plate until clamping the assembly shaft of the roller.

12. The attachment method according to claim 11, wherein the plate of the attachment device comprises two lateral guiding walls, at least partially extending between the first clamping surface and one or the other of the ramp or the sliding portion, where the lateral guiding walls are configured for engaging with the lateral sides of the tightening part, where the method comprises, during assembly of the tightening part on the plate, inserting the tightening part between the two lateral guiding walls of the plate.

13. The attachment method according to claim 12, wherein the two lateral guiding walls each comprise a guiding rib having a stop surface extending parallel to the rear surface of the plate, where a complementary stop surface of the tightening part is configured for engaging with the stop surface of the two guiding ribs of the plate, where the method comprises, during insertion of the guiding part between the lateral guiding walls, passing the complementary stop surface under the stop surface of the guiding ribs of the plate.
